(19) United States
(12) Patent Application Publication
(10) Pub. No.: US 2020/0041706 A1
(43) Pub. Date: Feb. 6, 2020

(54) POLARIZER AND DISPLAY DEVICE

(71) Applicant: BOE TECHNOLOGY GROUP CO., LTD., Beijing (CN)

(72) Inventors: Dejun BU, Beijing (CN); Paoming Tsai, Beijing (CN); Haoran Wang, Beijing (CN); Jianwei Li, Beijing (CN); Yongxiang Shi, Beijing (CN)

(21) Appl. No.: 16/434,971

(22) Filed: Jun. 7, 2019

(30) Foreign Application Priority Data
Aug. 2, 2018 (CN) 201810872882.9

(51) Int. Cl. G02B 5/30; G02B 1/14

(52) U.S. Cl. CPC G02B 5/305; G02B 1/14

(57) ABSTRACT

The present disclosure provides a polarizer and a display device, relating to the field of display technology, and alleviating the problem of warp or crease for the polarizer, which is caused by bending. The polarizer includes a polarizing substrate and a deformation controlling layer configured to suppress deformation of the polarizing substrate, the deformation controlling layer being on a surface of the polarizing substrate.

### RELATED APPLICATIONS

The present application claims the benefit of Chinese Patent Application No. 201810872882.9, filed on Aug. 2, 2018, the entire disclosures of which are incorporated herein by reference.

### TECHNICAL FIELD

The present disclosure relates to the field of display technology, and particularly to a polarizer and a display device.

### BACKGROUND

A flexible display device is a display device capable of bending, which has the characteristics of low power consumption, small size, and portability. A display surface of the flexible display device is provided with a polarizer to adjust the effect of the image displayed by the flexible display device.

At present, a polarizer is a composite film which has a function of shielding and transmitting incident light. A substrate of the polarizer can be obtained by a stretching process. Stretching causes the polarizer to have a certain internal stress. When the flexible display device is bent, the polarizer is prone to plastic deformation. Therefore, when the flexible display device is bent a plurality of times, the polarizer on the flexible display device may warp or appear a noticeable crease.

### SUMMARY

The present disclosure provides a polarizer including a polarizing substrate and a deformation controlling layer configured to suppress deformation of the polarizing substrate, the deformation controlling layer being located on a surface of the polarizing substrate.

In some embodiments, the polarizing substrate includes a first stretched layer; the deformation controlling layer includes a second stretched layer; a stretching direction of the first stretched layer and a stretching direction of the second stretched layer are not parallel to each other.

In some embodiments, an angle formed between the stretching direction of the first stretched layer and the stretching direction of the second stretched layer is not equal to 0° or 180°.

In some embodiments, an angle formed between the stretching direction of the first stretched layer and the stretching direction of the second stretched layer is equal to 90°.

In some embodiments, a shape of the first stretched layer is a rectangle; the stretching direction of the first stretched layer is parallel to a first side of the rectangle.

In some embodiments, a shape of the first stretched layer is a rectangle; the stretching direction of the first stretched layer is parallel to a diagonal of the rectangle.

In some embodiments, the polarizing substrate further includes a top protective layer and a bottom protective layer; the first stretched layer is located between the bottom protective layer and the top protective layer; the deformation controlling layer is located on a surface of the top protective layer facing away from the first stretched layer.

In some embodiments, the polarizer further includes a phase difference plate and a bonding layer; the phase difference plate is located on a surface of the polarizing substrate facing away from the deformation controlling layer, and the bonding layer is located on a surface of the phase difference plate facing away from the deformation controlling layer.

In some embodiments, a material of the deformation controlling layer is an organic polymer; and the deformation controlling layer has a thickness ranging from 3 μm to 50 μm.

In some embodiments, the deformation controlling layer is one selected from a polyvinyl alcohol stretched film, a linear low density polyethylene stretched film, and an ethylene-vinyl acetate copolymer stretched film.

The present disclosure further provides a display device including a display panel and the polarizer of the above-mentioned embodiments. The polarizer is located on a light exiting side of the display panel.

### BRIEF DESCRIPTION OF THE DRAWINGS

In order to more clearly illustrate the technical solutions in embodiments of the disclosure or in the prior art, the appended drawings needed to be used in the description of the embodiments or the prior art will be introduced briefly in the following. Obviously, the drawings in the following description are only some embodiments of the disclosure, and for those of ordinary skills in the art, other drawings may be obtained according to these drawings under the premise of not paying out creative work.

FIG. 1 is a structural schematic diagram of a polarizer according to an embodiment of the present disclosure;

FIG. 2 shows a relative positional relationship between a stretching direction of a first stretched layer and a stretching direction of a second stretched layer according to an embodiment of the present disclosure;

FIG. 3 shows a relative positional relationship between a stretching direction of a first stretched layer and a stretching direction of a second stretched layer according to another embodiment of the present disclosure; and

FIG. 4 is a structural schematic diagram of a display device according to an embodiment of the present disclosure.

### DETAILED DESCRIPTION OF THE DISCLOSURE

In the following, the technical solutions in embodiments of the disclosure will be described clearly and completely in connection with the drawings in the embodiments of the disclosure. Obviously, the described embodiments are only part of the embodiments of the disclosure, and not all of the embodiments. Based on the embodiments in the disclosure, all other embodiments obtained by those of ordinary skills in the art under the premise of not paying out creative work pertain to the protection scope of the disclosure.

The present disclosure provides a polarizer and a display device, alleviating the problem of warp or crease for the polarizer, which is caused by bending.

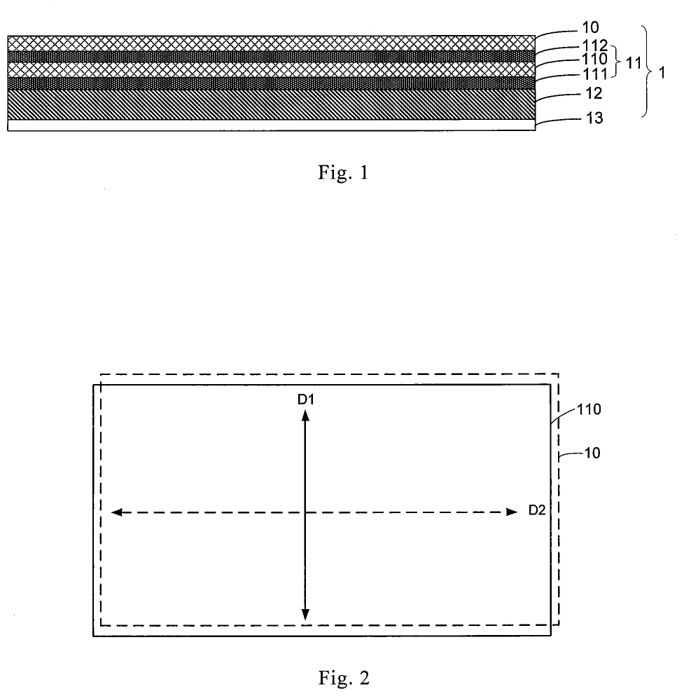

Referring to FIG. 1, the polarizer 1 provided by an embodiment of the present disclosure includes a polarizing substrate 11 and a deformation controlling layer configured to suppress deformation of the polarizing substrate 11. The deformation controlling layer is located on a surface of the polarizing substrate 11.

The polarizer 1 can be used in a conventional liquid crystal display device, and can also be used in an organic electroluminescence display device. Of course, the polarizer 1 can also be applied to other flexible objects. When the polarizer 1 is applied to a flexible object, if the flexible object is buckled or bent, the deformation controlling layer included in the polarizer 1 will suppress the deformation of the polarizing substrate 11, thereby alleviating the problem that the polarizer may be lifted up or creased from the surface of the flexible object. Thus, in the polarizer 1 provided in the embodiment of the present disclosure, the surface of the polarizing substrate 11 is formed with a deformation controlling layer that suppresses deformation of the polarizing substrate 11. In this way, when the polarizer 1 is bent, the deformation controlling layer can suppress the deformation of the polarizing substrate 11 to reduce the probability of plastic deformation for the polarizing substrate 11. Therefore, when the polarizer 1 provided by the embodiment of the present disclosure is applied to a flexible object such as a flexible display device, if the polarizer 1 is bent, the deformation controlling layer can suppress deformation of the polarizing substrate, thereby alleviating the problem that the polarizer 1 may be lifted up or creased from the surface of the flexible object.

In the related art, the stretched layer obtained by a stretching process has internal stresses in both the stretching direction and the non-stretching direction. Therefore, when the stretched layer is bent, it is liable to be deformed remarkably, resulting in occurrence of creases in the stretched layer, and the stretched layer may even be lifted up from the surface of the substrate to which the stretched layer is attached.

Based on this, in some embodiments of the present disclosure, as shown in FIGS. 1-3, the polarizing substrate 11 includes a first stretched layer 110, and the deformation controlling layer may include a second stretched layer 10. The stretching direction D1 of the first stretched layer and the stretching direction D2 of the second stretched layer 10 are not parallel to each other. In the context of the present disclosure, each stretched layer is obtained by stretching an initial film layer (for example, an organic polymer layer) along a stretching direction in a stretching process.

Qualitatively, when the polarizer 1 is attached to a flexible object, if the flexible object is bent, the portion of the second stretched layer 10 that has not been lifted presses the portion of the first stretched layer 110 that has been lifted, thereby reducing the warping degree of the first stretched layer 110. The portion of the first stretched layer 110 that has not been lifted does not exacerbate the warping of the second stretched layer 10, so that the warping degree of the second stretched layer 10 is relatively low. Therefore, when the polarizer 1 provided by the embodiment of the present disclosure is attached to a flexible object, and the probability of the polarizer 1 being warped or creased is lowered.

Quantitatively, when the polarizer 1 is attached to a flexible object, the first stretched layer 110 and the second stretched layer 10 may undergo a certain deformation. However, the deformation direction of the first stretched layer 110 is different from the deformation direction of the second stretched layer 10, so that the component of the deformation force of the second stretched layer 10 in the deformation direction of the first stretched layer 110 is reduced. Moreover, the component of the deformation force of the first stretched layer 110 in the deformation direction of the second stretched layer 10 is reduced, thereby weakening the crease caused by the bending of the polarizer 1 or reducing the possibility of lifting up the polarizer 1 from the flexible object.

Exemplarily, the stretching direction D1 of the first stretched layer and the stretching direction D2 of the second stretched layer are not parallel to each other. An angle formed between the stretching direction D1 of the first stretched layer and the stretching direction D2 of the second stretched layer is not equal to 0° or 180°.

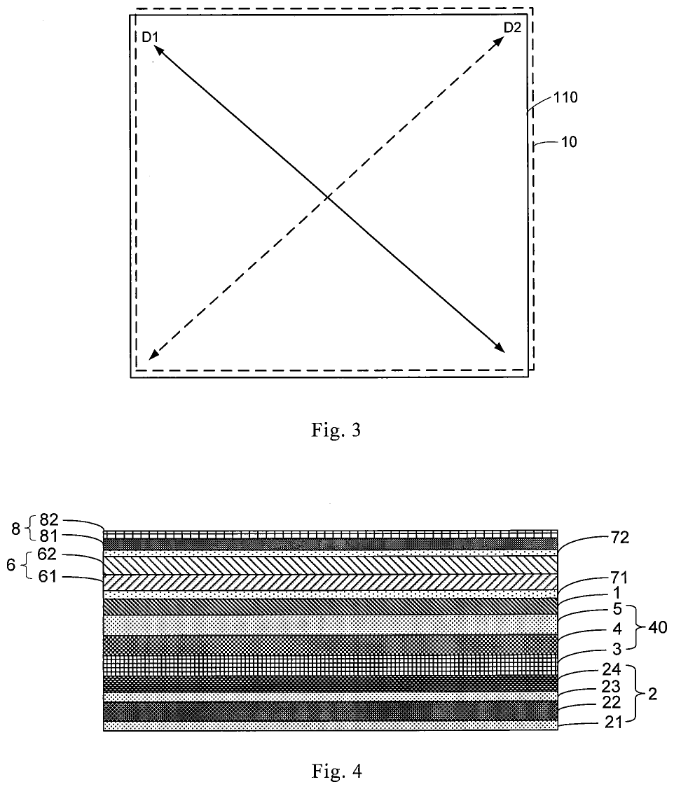

Optionally, as shown in FIGS. 2 and 3, the angle formed between the stretching direction D1 of the first stretched layer and the stretching direction D2 of the second stretched layer is equal to 90°.

Qualitatively, when the polarizer 1 is attached to a flexible object, if the flexible object is bent, the lifted edge of the first stretched layer 110 and the lifted edge of the second stretched layer are perpendicular to each other. Then the portion of the second stretched layer that has not been lifted presses the most uplifted portion of the first stretched layer 110, thereby maximally reducing the warping degree of the first stretched layer 110. Since the lifted edge of the first stretched layer 110 and the lifted edge of the second stretched layer are perpendicular to each other, the portion of the first stretched layer 110 that has not been lifted is spatially corresponding to the most uplifted portion of the second stretched layer. Therefore, the first stretched layer 110 does not exacerbate the warping of the second stretched layer at all.

In this embodiment, it can be seen that, the angle formed between the stretching direction D1 of the first stretched layer and the stretching direction D2 of the second stretched layer is equal to 90°, the polarizer 1 provided by the embodiment of the present disclosure is attached to a flexible object, the polarizer 1 has the lowest probability of being warped or creased.

Quantitatively, when the polarizer 1 is attached to a flexible object, although the first stretched layer 110 and the second stretched layer undergo a certain deformation, an angle of 90° is formed between the deformation direction of the first stretched layer 110 and the deformation direction of the second stretched layer. This deformation force of the first stretched layer 110 has no component force in the deformation direction of the second stretched layer, and the deformation force of the second stretched layer has no component force in the deformation direction of the first stretched layer 110. Therefore, in this embodiment, the angle formed between the stretching direction D1 of the first stretched layer and the stretching direction D2 of the second stretched layer is equal to 90°, the polarizer 1 provided by the embodiment of the present disclosure is attached to a flexible object, the polarizer 1 has the lowest probability of being warped or creased.

Exemplarily, as shown in FIG. 2, the shape of the first stretched layer 110 is a rectangle, and the rectangle may be rectangular or square. The stretching direction D1 of the first stretched layer is parallel to a first side of the rectangle. In an embodiment, the angle formed between the stretching direction D1 of the first stretched layer and the stretching direction D2 of the second stretched layer is equal to 90°, the stretching direction D2 of the second stretched layer 10 is parallel to a second side of the rectangle. The first side and the second side of the rectangle are perpendicular to each other.

Exemplarily, as shown in FIG. 3, the shape of the first stretched layer 110 is a rectangle. The stretching direction Dl of the first stretched layer 110 is parallel to a first diagonal of the rectangle. In an embodiment, the angle formed between the stretching direction D1 of the first stretched layer and the stretching direction D2 of the second stretched layer is equal to 90°, and the rectangle is square. The stretching direction D2 of the second stretched layer 10 is parallel to the second diagonal of the rectangle. The first diagonal and the second diagonal of the rectangle are perpendicular to each other.

As shown in FIG. 1, the polarizer 1 provided in the above embodiment may be a linear polarizer, and the polarizing substrate 11 further includes a bottom protective layer 111 and a top protective layer 112. The first stretched layer 110 is located between the bottom protective layer 111 and the top protective layer 112. The deformation controlling layer is located on a surface of the top protective layer 112 facing away from the first stretched layer 110. Since the first stretched layer 110 is located between the bottom protective layer 111 and the top protective layer 112, the bottom protective layer 111 and the top protective layer 112 may protect the first stretched layer 110.

As shown in FIG. 1, the polarizer 1 provided in the above embodiment may be a circular polarizer, the polarizer 1 further includes a phase difference plate 12 and a bonding layer 13. The phase difference plate 12 is located between the surface of the polarizing substrate 11 facing away from the deformation controlling layer and the bonding layer 13. Optionally, the polarizing substrate 11 includes the bottom protective layer 111, the top protective layer 112, and the first stretched layer 110 between the bottom protective layer 111 and the top protective layer 112. The phase difference plate 12 is located on a surface of the bottom protective layer 111 facing away from the first stretched layer 110. The bonding layer 13 is located on a surface of the phase difference plate 12 facing away from the first stretched layer 110.

The material of the first stretched layer 110 may be an organic polymer. The first stretched layer may be one selected from a polyvinyl alcohol stretched film, a linear low density polyethylene stretched film, and an ethylene-vinyl acetate copolymer stretched film or the like. The first stretched layer 110 may have a thickness ranging from 3 μm to 50 μm.

The thickness of the first stretched layer 110 is 3 μm to 10 μm. With such a configuration, the first stretched layer 110 can suppress the deformation of the polarizing substrate 11 well, while the thickness of the polarizer 1 is not increased excessively.

In addition, the materials of the above-mentioned bonding layer 13, bottom protective layer 111, and top protective layer 112 are various. For example, the bonding layer may be made of photosensitive adhesive or pressure sensitive adhesive or the like, which is not limited thereto; the bottom protective layer 111 may be a cellulose triacetate film, but is not limited thereto; the top protective layer 112 is a cellulose triacetate film or an acrylic film, but is not limited thereto.

As shown in FIG. 4, an embodiment of the present disclosure further provides a display device including a display panel 40 and the polarizer 1 provided by the above embodiments. The polarizer 1 is located on a light exiting side of the display panel 40. The polarizer 1 may be a linearly polarizer or a circular polarizer.

The beneficial effects of the display device provided by the embodiment of the present disclosure are the same as those of the polarizer 1 provided in the above embodiments, and are not described herein.

The display device provided in the above-mentioned embodiment may be any product or component having a display function, such as a mobile phone, a tablet computer, a television, a display, a notebook computer, a digital photo frame, or a navigator.

Exemplarily, as shown in FIG. 4, the above display device includes: a flexible substrate 2, an array substrate 3, a light-emitting layer 4, an encapsulation layer 5, a polarizer 1, a touch layer 6, and a top cover 8. The array substrate 3, the light-emitting layer 4, the encapsulation layer 5, the polarizer 1, the touch layer 6, and the top cover 8 are stacked on the surface of the flexible substrate 2 along a direction away from the surface of the flexible substrate 2. The display panel 40 may include the array substrate 3, the light emitting layer 4, and the encapsulation layer 5.

As shown in FIG. 4, the flexible substrate 2 includes a bottom buffer layer 21, a bottom support layer 22, a photosensitive adhesive layer 23, and a polyamide substrate layer 24 laminated in sequence. The touch layer 6 includes a touch substrate layer 61 and a touch sensing layer 62 laminated with each other. The touch substrate layer 61 is generally made of polyterephthalic plastic. The top cover 8 includes a top encapsulation film 81 and a top protective film 82 laminated with each other. The bottom support layer 22 is bonded to the array substrate 3 via the photosensitive adhesive layer 23. The touch substrate layer 61 is located between the touch sensing layer 62 and the polarizer 1. The touch sensing layer 62 is located between the touch substrate layer 61 and the top encapsulation film 81.

Further, as shown in FIG. 4, the polarizer 1 is bonded to the touch substrate layer 61 via a first optical adhesive layer 71, and the touch sensing layer 62 is bonded to the top encapsulation film 81 via a second optical adhesive layer 72.

When the polarizer 1 has the structure shown in FIG. 1, as shown in FIGS. 1 and 4, the bonding layer 13 of the polarizer 1 is bonded to the encapsulation layer 5, and the deformation controlling layer of the polarizer 1 is bonded to the touch substrate layer 61 via the first optical adhesive layer 71.

It can be understood that the thickness of each film layer in the above display device can be set according to actual needs. For example, the thickness of the bottom support layer 22 is generally 75 μm, the thickness of the photosensitive adhesive layer is generally 25 μm, the thickness of the polyamide substrate layer 24 is generally 20 μm, the thickness of the array substrate 3 is generally 5 μm, and the thickness of the encapsulation layer 5 is 10 μm.

In the description of the above embodiments, specific features, structures, materials or characteristics may be combined in any suitable manner in any one or more embodiments or examples.

In the polarizer provided by the present disclosure, the surface of the polarizing substrate is provided with the deformation controlling layer for suppressing deformation of the polarizing substrate. When the polarizer is bent, the deformation controlling layer can suppress deformation of the polarizing substrate to reduce the probability of plastic deformation for the polarizing substrate. Therefore, the polarizer provided by the present disclosure can be applied to a flexible object such as a flexible display device; if the polarizer is bent, the deformation controlling layer can suppress deformation of the polarizing substrate, thereby alleviating the problem that the polarizer may be lifted up or creased from the surface of the flexible object.

The above embodiments are only used for explanations rather than limitations to the present disclosure, the ordinary skilled person in the related technical field, in the case of not departing from the spirit and scope of the present disclosure, may also make various modifications and variations, therefore, all the equivalent solutions also belong to the scope of the present disclosure, the patent protection scope of the present disclosure should be defined by the claims.

What is claimed is:

1. A polarizer, comprising:
a polarizing substrate; and
a deformation controlling layer configured to suppress deformation of the polarizing substrate,
wherein the deformation controlling layer is on a surface of the polarizing substrate.

2. The polarizer according to claim 1,
wherein the polarizing substrate comprises a first stretched layer,
wherein the deformation controlling layer comprises a second stretched layer, and
wherein a first stretching direction of the first stretched layer and a second stretching direction of the second stretched layer are not parallel to each other.

3. The polarizer according to claim 2,
wherein an angle between the first stretching direction of the first stretched layer and the second stretching direction of the second stretched layer is not equal to 0° and is not equal to 180°.

4. The polarizer according to claim 2,
wherein an angle between the first stretching direction of the first stretched layer and the second stretching direction of the second stretched layer is equal to 90°.

5. The polarizer according to claim 2,
wherein a shape of the first stretched layer comprises a rectangle, and
wherein the first stretching direction of the first stretched layer is parallel to a first side of the rectangle.

6. The polarizer according to claim 2,
wherein a shape of the first stretched layer comprises a rectangle, and
wherein the first stretching direction of the first stretched layer is parallel to a diagonal of the rectangle.

7. The polarizer according to claim 2,
wherein the polarizing substrate further comprises a top protective layer and a bottom protective layer,
wherein the first stretched layer is between the bottom protective layer and the top protective layer, and
wherein the deformation controlling layer is on a surface of the top protective layer facing away from the first stretched layer.

8. The polarizer according to claim 1, wherein the surface of the polarizing substrate comprises a first surface of the polarizing substrate, the polarizer further comprising:
a phase difference plate; and
a bonding layer,
wherein the phase difference plate is on a second surface of the polarizing substrate facing away from the deformation controlling layer, and
wherein the bonding layer is on a surface of the phase difference plate facing away from the deformation controlling layer.

9. The polarizer according to claim 1,
wherein a material of the deformation controlling layer comprises an organic polymer, and
wherein the deformation controlling layer has a thickness ranging from 3 μm to 50 μm.

10. The polarizer according to claim 1,
wherein the deformation controlling layer is one selected from a polyvinyl alcohol stretched film, a linear low density polyethylene stretched film, or an ethylene-vinyl acetate copolymer stretched film.

11. A display device comprising a display panel and the polarizer of claim 1,
wherein the polarizer is on a light exiting side of the display panel.

12. The display device according to claim 11,
wherein the polarizing substrate comprises a first stretched layer,
wherein the deformation controlling layer comprises a second stretched layer,
wherein a first stretching direction of the first stretched layer and a second stretching direction of the second stretched layer are not parallel to each other.

13. The display device according to claim 12,
wherein an angle between the first stretching direction of the first stretched layer and the second stretching direction of the second stretched layer is not equal to 0° and is not equal to 180°.

14. The display device according to claim 12,
wherein an angle between the first stretching direction of the first stretched layer and the second stretching direction of the second stretched layer is equal to 90°.

15. The display device according to claim 12,
wherein a shape of the first stretched layer comprises a rectangle, and
wherein the first stretching direction of the first stretched layer is parallel to a first side of the rectangle.

16. The display device according to claim 12,
wherein a shape of the first stretched layer comprises a rectangle, and
wherein the first stretching direction of the first stretched layer is parallel to a diagonal of the rectangle.

17. The display device according to claim 12,
wherein the polarizing substrate further comprises a top protective layer and a bottom protective layer,
wherein the first stretched layer is between the bottom protective layer and the top protective layer, and
wherein the deformation controlling layer is on a surface of the top protective layer facing away from the first stretched layer.

18. The display device according to claim 11, wherein the surface of the polarizing substrate comprises a first surface of the polarizing substrate, the display device further comprising:
a phase difference plate; and
a bonding layer,
wherein the phase difference plate is on a second surface of the polarizing substrate facing away from the deformation controlling layer, and
wherein the bonding layer is on a surface of the phase difference plate facing away from the deformation controlling layer.

19. The display device according to claim 11,
wherein a material of the deformation controlling layer comprises an organic polymer, and
wherein the deformation controlling layer has a thickness ranging from 3 μm to 50 μm.

20. The display device according to claim 11,
wherein the deformation controlling layer is one selected from a polyvinyl alcohol stretched film, a linear low density polyethylene stretched film, or an ethylene-vinyl acetate copolymer stretched film.
